(19) United States
(12) Patent Application Publication
(10) Pub. No.: US 2025/0304307 A1
(43) Pub. Date: Oct. 2, 2025

(54) SYSTEM AND METHOD FOR IMPROVED LABELLING OF CONTAINERS

(71) Applicant: The Procter & Gamble Company, Cincinnati, OH (US)

(72) Inventors: Johann DUGGE, Schaerbeek (BE); Glen Barry MOONEY, La Hulpe (BE); Julio MUÑIZ-FERNANDEZ, Brussels (BE)

(21) Appl. No.: 19/090,506

(22) Filed: Mar. 26, 2025

(30) Foreign Application Priority Data
Mar. 28, 2024 (EP) 24167688.1

(51) Int. Cl. B65C 9/42; B65C 9/00; B65C 9/02; B65C 9/18

(52) U.S. Cl. CPC B65C 9/42; B65C 9/0006; B65C 9/02; B65C 9/1869; B65C 2009/0009

(57) ABSTRACT

An apparatus is provided for improving the labelling process of containers. The apparatus includes a container carrier arranged in a travel lane. The travel lane has a downstream direction in which the carrier is movable. The apparatus also includes a deformable panel comprising a fixed end and a free end. The deformable panel is positioned angled to and intersecting the travel lane. The free end is more proximal to the travel lane than the fixed end. The apparatus also includes a displacement sensor measuring the displacement at the deformable panel. A method is also provided for detecting an operational condition of the apparatus.

### FIELD

The present disclosure relates generally to labelling containers and more specifically to a system and method for improving the labelling of containers.

### BACKGROUND

In high volume, highly automatized production (e.g. manufacture of consumer goods done at high speed) it is desirable to minimize the cost of yield of target-quality product and to use materials, capital and labor as effectively as possible. Typically, using lower cost materials implies higher variability that may be detrimental to quality yield, and require more labor to tune the process, or more expensive machines that can absorb this variability. Various combinations of tradeoffs are possible, however as these production processes are often very complex, they are difficult to optimize and to maintain in an optimal state. For example, in the process of applying self-adhesive labels to bottles, the successful transformation depends on many subcomponents being set up and performing correctly with proper operational parameters (e.g., bottle inflation pressure, bottle position and rotation) that can impact label placement.

Further, for high-speed (cyclic, repetitive) manufacturing the process is parallelized (applying front and back labels simultaneously, turning bottles into position) and redundant (while a label reel is replenished on one applicator, a second applicator takes over). This introduces the problem that the same process is performed on different units, which is another source for variability.

Variability in the process can lead to quality outages. For example, one or more of the front/back labels may be misaligned with respect to the bottle upon which it is placed. As another example, one or more of the front or back labels may comprise wrinkles in the label which is not consumer appealing. Additionally, variability in the process can lead to loose parts of the labels on the bottles (e.g. loose corners).

The discussion of shortcomings and needs existing in the field prior to the present disclosure is in no way an admission that such shortcomings and needs were recognized by those skilled in the art prior to the present disclosure.

### SUMMARY

Various aspects of the disclosure solve the above-mentioned problems and provide methods and devices useful for gaining critical insights to optimize high speed, complex, parallelized and/or cyclic manufacturing processes by equipping the machine with instrumentation that can sense a multitude of variables simultaneously, and present the data in a manner that is easy and quick to interpret to spot any systematic or random process deviations.

It was recognized that conventional methods for monitoring the quality of the labelling process of containers typically involves an operator performing regular manual inspections (e.g. every 30 minutes) of labelled containers at the output of the labelling process. The operator manually inspects these labelled containers for defects (e.g. wrinkles in the label, loose parts such as loose corners, etc.) and determines whether they are acceptable or not. If the defects are deemed unacceptable, the operator must then proceed to troubleshooting to pinpoint the cause of the defect. This troubleshooting is difficult for the operator to manually pinpoint. For example, since every container (e.g. bottle) has different variations in its shape, the defect may be due to the variation in the shape of a particular bottle rather than an operational condition of the labelling system.

Additionally, other conventional systems and methods attempt to solve these problems with sensors that are physically mounted to various components of the system, such as a label applicator panel that applies the labels to the containers. However, it was recognized that this approach is not optimal for multiple reasons. First, the physical mounting of a sensor to the components of the system (e.g. a label applicator panel) impacts the process inadvertently and thus potentially introduces additional variability into the process. Second, these components (e.g. the label applicator panel) to which the sensors are mounted frequently undergo repair and/or replacement which then introduces additional unnecessary steps such as removing the sensor from the replaced component. Third, it is difficult to interpret the data provided by these sensors (e.g. vibration sensors) in order to determine what specific operational condition is responsible for the observed defect in the labelling process, let alone how to cure the specific operational condition. To address this issue, the disclosure herein discloses a system with a non-contact sensor that is used to measure data that is used to detect and/or reduce variability in the process.

In a first set of aspects of the disclosure, an apparatus is provided for improving the labelling process of containers. The apparatus includes a container carrier arranged in a travel lane. The travel lane has a downstream direction in which the carrier is movable. The apparatus also includes a label applicator panel, comprising a fixed end and a free end. The label applicator panel is positioned angled to and intersecting the travel lane. The free end is more proximal to the travel lane than the fixed end. The apparatus also includes a displacement sensor for measuring a displacement of the label applicator panel.

In a second set of aspects of the disclosure, a method is provided for detecting an operational condition of the apparatus of the first set of aspects of the disclosure. The method includes a step of providing a plurality of containers engaged with the container carriers. The method further includes the step of conveying the container carriers and containers engaged therewith past the label applicator panel. The method further includes the step of measuring a distance from the displacement sensor to the label applicator panel as each container carrier is conveyed past the label applicator panel to generate a distance profile. The method further includes the step of associating the distance profile with a unique container carrier. The method further includes the step of recording each distance profile associated with each unique container carrier in a distance profile array associated with each unique container carrier.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which illustrate examples according to various embodiments.

FIG. 1A is an example according to various aspects illustrating a block diagram of an apparatus for improving the labelling of containers on container carriers;

FIG. 1B is an example according to various aspects illustrating the apparatus of FIG. 1A with a label applicator panel in an undeflected position;

FIG. 1C is an example according to various aspects illustrating the apparatus of FIG. 1B with the label applicator panel in a deflected position by a container;

FIG. 1D is an example according to various aspects illustrating the apparatus of FIG. 1B with the label applicator panel in the undeflected position after deflection by the container;

FIG. 1E is an example according to various aspects illustrating the apparatus of FIG. 1B including a spatial relationship between the peeler bar and the label applicator panel;

FIG. 1F is an example according to various aspects illustrating the apparatus of FIG. 1B with a plurality of back plates mounted to the label applicator panel;

FIG. 2A is an example according to various aspects illustrating a graph with a distance profile indicating a displacement of the label applicator panel between FIGS. 1B and 1D;

FIG. 2B is an example according to various aspects illustrating a graph with a plurality of distance profiles indicating displacement of the label applicator panel of FIG. 1A due to the plurality of containers;

FIG. 3A is an example according to various aspects illustrating a block diagram of an apparatus for improving the labelling of containers on container carriers that move in a circular travel lane;

FIG. 3B is an example according to various aspects illustrating an image of a label with a wrinkle applied to a bottle using the apparatus of FIG. 3A;

FIG. 3C is an example according to various aspects illustrating an image of the label on the bottle of FIG. 3B using a spectrum to depict surface variations;

FIG. 4A is an example according to various aspects illustrating a graph with distance profile arrays for the front labelling heads of FIG. 3A;

FIG. 4B is an example according to various aspects illustrating a graph with distance profile arrays for the back labelling heads of FIG. 3A;

FIGS. 4C through 4F are examples according to various aspects illustrating a respective graph with a respective distance profile array for each respective head of FIG. 3A;

FIG. 4G is an example according to various aspects illustrating a graph with a plurality of distance profiles indicating displacement of one of the heads of FIG. 3A;

FIG. 5 is an example according to various aspects illustrating a flow chart depicting steps of a method for detecting an operational condition of the apparatus of FIG. 1A;

FIG. 6A is an example according to various aspects illustrating a graph with a distance profile array for one of the heads of FIG. 3A;

FIG. 6B is an example according to various aspects illustrating the distance profile array of FIG. 6A separated into clusters according to different container carriers;

FIG. 7A is an example according to various aspects illustrating a graph with distance profiles indicating a simulated displacement of the label applicator panel based on respective operational conditions of the apparatus of FIG. 1A;

FIGS. 7B through 7D are examples according to various aspects illustrating different operational conditions in the simulated displacement of each distance profile in FIG. 7A;

FIG. 7E is an example according to various aspects illustrating a graph with distance profiles indicating simulated displacement of the label applicator panel based on various operational conditions of the apparatus;

FIGS. 8A and 8B are examples according to various aspects illustrating the distance profile array for one of the heads before and after performing the method of FIG. 5;

FIG. 9 is an example according to various aspects illustrating a block diagram of a computer system upon which an aspect of the disclosure may be implemented;

FIG. 10 is an example according to various aspects illustrating a block diagram of a chip set upon which an aspect of the disclosure may be implemented; and

FIG. 11 is an example according to various aspects illustrating a block diagram of a mobile terminal for communications which is capable of operating in the apparatus of FIG. 1A.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Disposed on” refers to a positional state indicating that one object or material is arranged in a position adjacent to the position of another object or material. The term does not require or exclude the presence of intervening objects, materials, or layers.

### Apparatus for Improving the Labelling of Containers

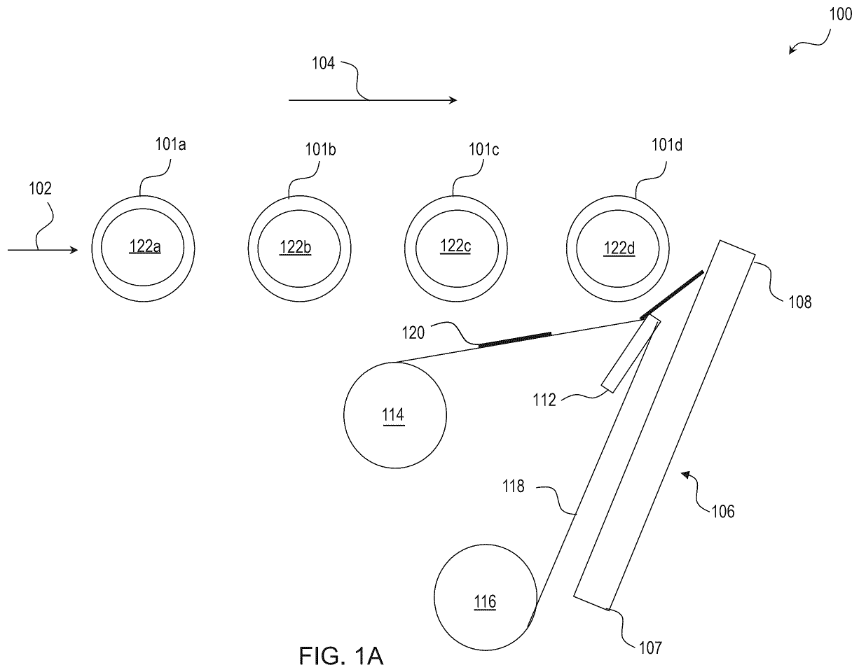

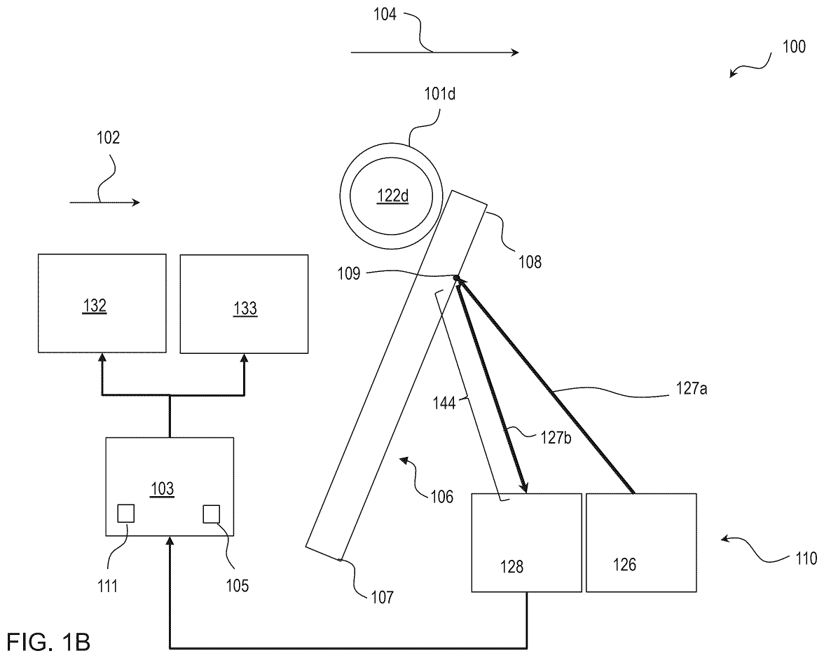

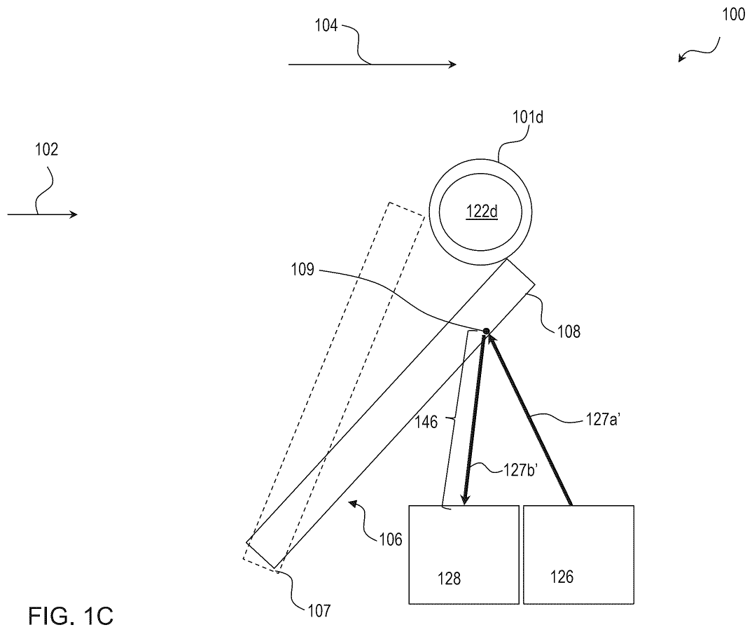

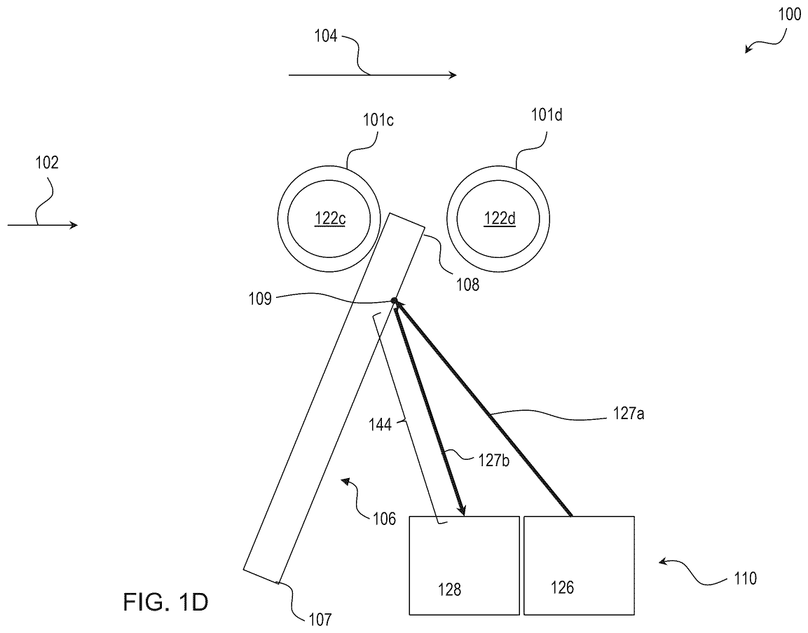

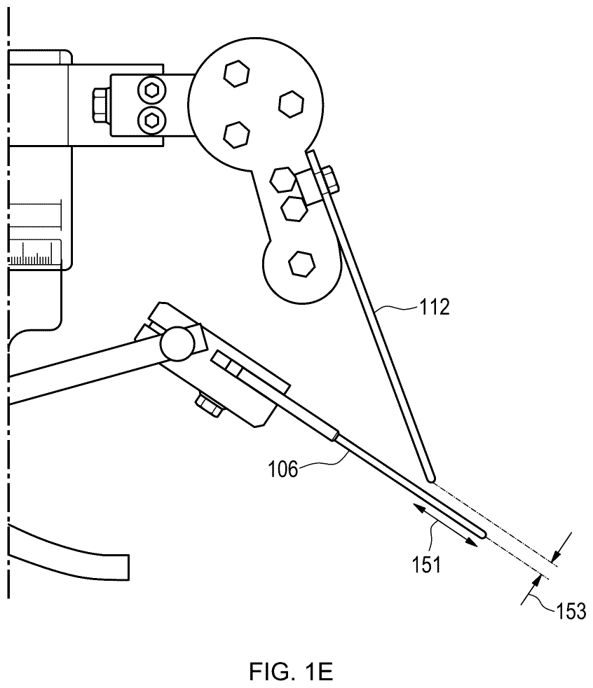

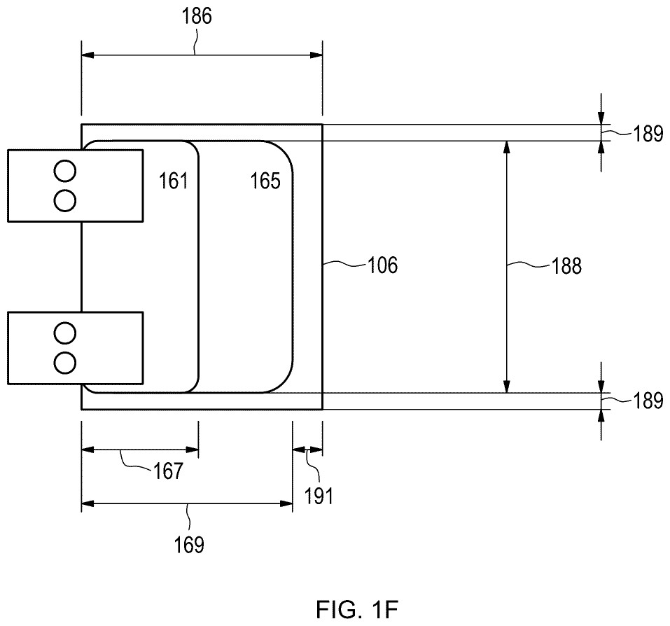

FIG. 1A is an example according to various aspects illustrating a block diagram of an apparatus 100 for improving the labelling of containers 122 on container carriers 101. As shown in FIG. 1A, in one aspect the apparatus 100 includes a container carrier, such as a plurality of spaced apart container carriers 101a through 101d arranged in a travel lane 102. The travel lane 102 has a downstream direction 104 in which the carriers 101a through 101d are movable. Although four containers and four container carriers are depicted in FIG. 1A, in other aspects less or more than four containers and container carriers are provided.

Although FIG. 1A depicts that the container carrier is a plurality of spaced apart container carriers 101a through 101d arranged in the travel lane 102 to carry the respective containers 122a through 122d, in other aspects of the disclosure the container carrier is a continuous surface that carries the containers 122a through 122d along the travel lane 102, such as a continuous belt or similar continuous surface. As further shown in FIG. 1A, in an aspect the apparatus 100 also includes a label applicator panel 106 comprising a fixed end 107 and a free end 108. In some aspects, the label applicator panel 106 is a deformable panel. In other aspects, the label applicator panel 106 is non-deformable (e.g., a firm panel connected to a movable arm which is able to rotate away and spring back around a fixed point). Thus, while the aspects of the disclosure discussed herein involve a deformable panel 106, these aspects of the disclosure could also be utilized with a non-deformable panel 106. The fixed end 107 may be pivotally mounted to a fixed component of the apparatus 100 (not shown). The deformable panel 106 may be positioned angled to the travel lane 102, where the free end 108 is more proximal to the travel lane 102 than the fixed end 107. As further shown in FIG. 1A, the free end 108 is positioned within the travel lane 102.

Some components of the apparatus 100 that perform the labelling of the containers 122 will now be discussed. As shown in FIG. 1A, the apparatus 100 includes a peeler bar 112 upstream of the deformable panel 106. The peeler bar 112 may be operationally positioned between a label unwind mandrel 114 and a rewind mandrel 116 such that a web 118 carrying a plurality of pressure sensitive labels 120 passes from the label unwind mandrel 114 over the peeler bar 112 and to the rewind mandrel 116. As further shown in FIG. 1A, in one aspect the deformable panel 106 is operationally positioned to contact the pressure sensitive label 120 when the pressure sensitive label 120 is detached or partially detached from the web with the peeler bar 112. The deformable panel 106 then applies the pressure sensitive label 120 to the container 122 as the container 122 impacts the deformable panel 106 and causes the deformable panel 106 to rotate or pivot.

For ease of illustration, the peeler bar 112, label unwind mandrel 114 and the rewind mandrel 116 are not depicted in FIGS. 1B through 1D although they are still included in the depicted apparatus 100.

Those components of the apparatus 100 which are used to detect an operational condition with the labelling system will now be discussed. FIG. 1B is an example according to various aspects illustrating the apparatus 100 of FIG. 1A with the deformable panel 106 in an undeflected position. As shown in FIG. 1B, in the undeflected position the container 122d has not yet impacted the deformable panel 106 and thus has not yet displaced the deformable panel 106. As shown in FIG. 1B, the apparatus 100 includes a displacement sensor 110 measuring a displacement of the deformable panel 106. In one aspect, the displacement sensor 110 include a laser source 126 that transmits a laser signal 127a at a fixed position 109 on the deformable panel 106 and a laser sensor 128 that receives a laser signal 127b after reflecting from the fixed position 109 on the deformable panel 106. In one example aspect, the laser signal 127 is visible light (e.g., 630 nanometers or nm) and the laser source 106 is class 2, model: OptoNCDT® 1420-100. As shown in FIG. 1B, in some aspects the laser source 126 and the laser sensor 128 are aligned or targeted in a direction that is angled relative to the travel lane 102. Accordingly, the transmitted laser signal 127a and the reflected laser signal 127b are oriented in a direction that is angled relative to the travel lane 102. However, in other aspects the laser source 126 and laser sensor 128 could be aligned in a direction parallel to the travel lane 102.

Although FIG. 1B depicts a laser source and a laser sensor, any non-contact sensor can be utilized for the displacement sensor 110 such as but not limited to an optical sensor (e.g. other than a laser sensor), a finite element analysis sensor, a magnetic sensor, a vibration sensor, an acoustic sensor and a visual sensor (e.g. camera that captures images of the deformable panel 106 to measure displacement). In the example aspect of a visual sensor (e.g. camera) an additional sensor could be utilized that transmits a signal to the visual sensor to capture an image of the deformable panel 106 at one or more discrete (e.g. three) times during the application of the label 120 to the container 122 with the deformable panel 106. For purposes of this description, “non-contact sensor” means a sensor that is configured to measure a displacement of the deformable panel 106 while not being in physical contact with or physically coupled to the deformable panel 106.

It was recognized that one advantage of using a non-contact sensor (e.g. laser sensor 128) is that it can be used to verify that the deformable panel 106 is located in a same position as a previous time (e.g. FIGS. 1B and 1D both depict the same distance 144 between the deformable panel position 109 and the laser sensor 128). Thus, by using the non-contact sensor this can advantageously ensure that during initial setup of the apparatus 100, the deformable panel 106 and the deformable panel position 109 are located in the correct position. Although various non-contact sensors are discussed herein, in some aspects of the disclosure the laser source and laser sensor are particularly suitable as they combine many desirable qualities: high resolution in time (sub-millisecond, yielding dozens of points per passing product; continuous acquisition at high rate negates the need to trigger the signal acquisition precisely synchronized with the machine state and allowing taking measurements without any electrical integration with the machine), high resolution in space (sub-millimeter) and high repeatability, which allow detecting minute effects on the profile caused by different process parameters or conditions; the contact-less nature also enables using the same sensor for different products (wipes change parts) without having to reconfigure/reattach the sensor; the solid-state nature of the sensor also makes it low maintenance.

A controller is also provided in the apparatus which is used to detect an operational condition with the labelling system. As shown in FIG. 1B, in some aspects the apparatus 100 includes a controller 103 that is communicatively coupled with the laser sensor 128. The controller 103 receives data from the laser sensor 128 that indicates a value of one or more parameters of the detected laser signal 127b. In one example aspect, this parameter is an angle at which the laser signal 127b is detected at the laser sensor 128. In another example aspect, this parameter is a position along the laser sensor 128 that detects the laser signal 127b. Based on the value of these parameters of the detected laser signal 127b, the controller 103 determines a distance 144 separating the deformable panel position 109 and the laser sensor 128. As appreciated by one of ordinary skill in the art, the laser sensor 128 is calibrated such that the value of the distance between the deformable panel position 109 and the laser sensor 128 is known or predetermined based on the value of the parameters of the detected laser signal 127b detected by the laser sensor 128. In one example aspect, the controller 103 includes a memory 111 that stores this data, such as in a database that correlates the value of the parameters of the detected laser signal 127b with the value of the distance between the panel position 109 and the laser sensor 128.

In some aspects, the laser sensor 128 employs triangulation to determine the distance 144, which involves distance measurement by angle calculation. As appreciated by one of ordinary skill in the art, in measurement technology, the reflected laser signal 127b falls incident onto the laser sensor 128 at a certain location and at a certain angle depending on the distance to the deformable panel position 109. Based on the detected position of the laser signal 127b on the laser sensor 128 and a distance from the laser source 126 to the laser sensor 128, the distance 144 to the deformable panel position 109 is calculated (e.g. in the sensor 128).

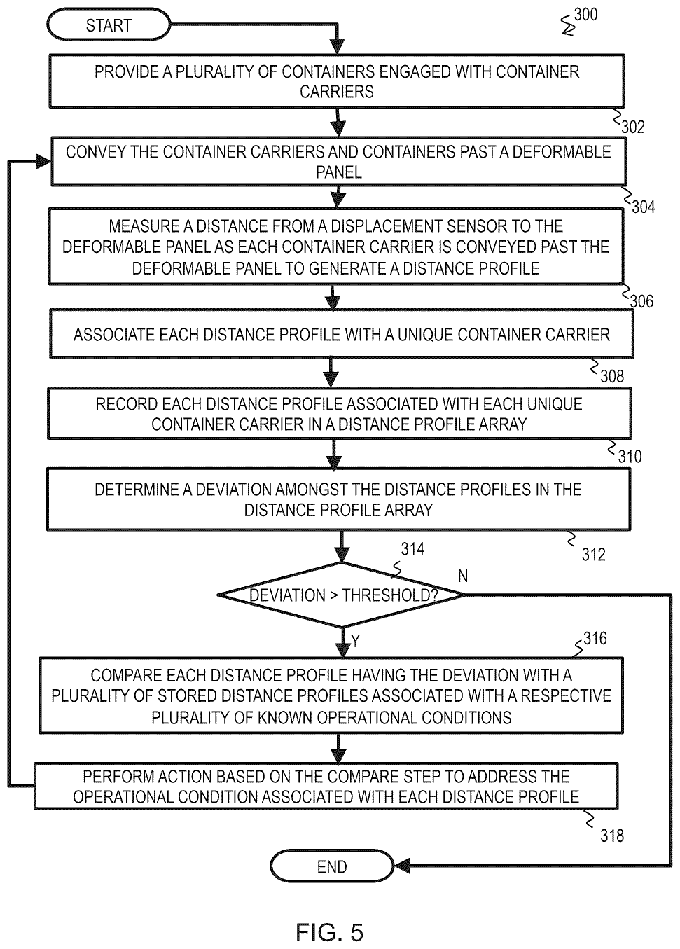

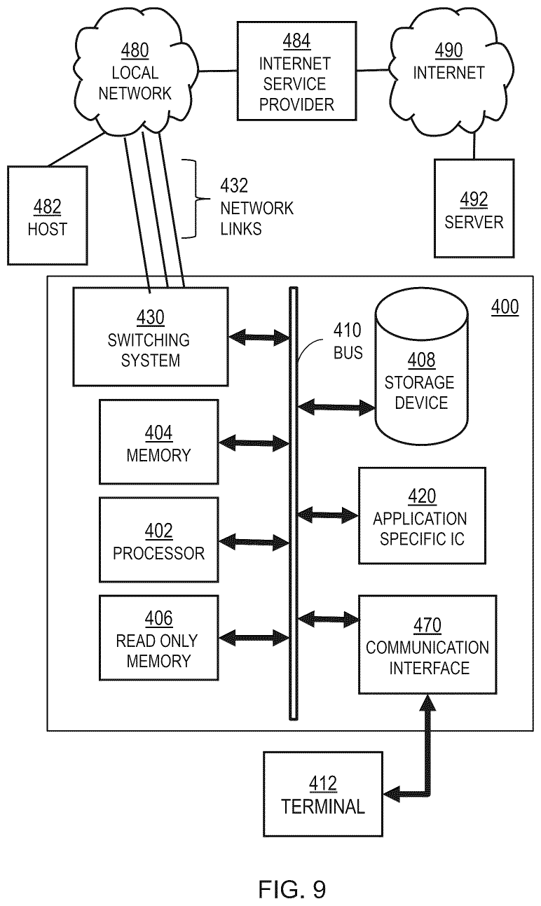

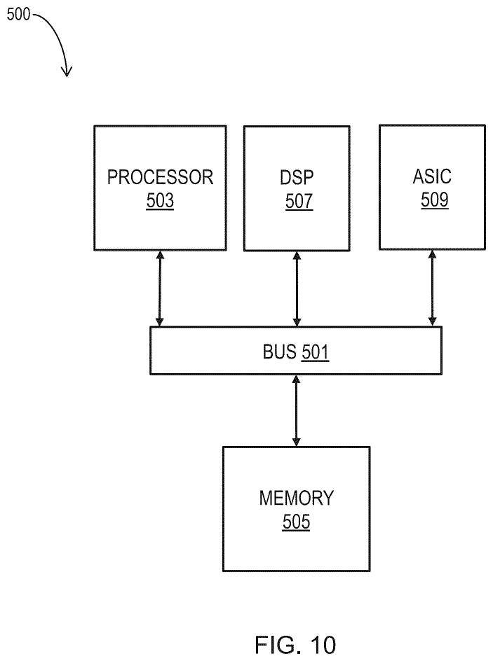

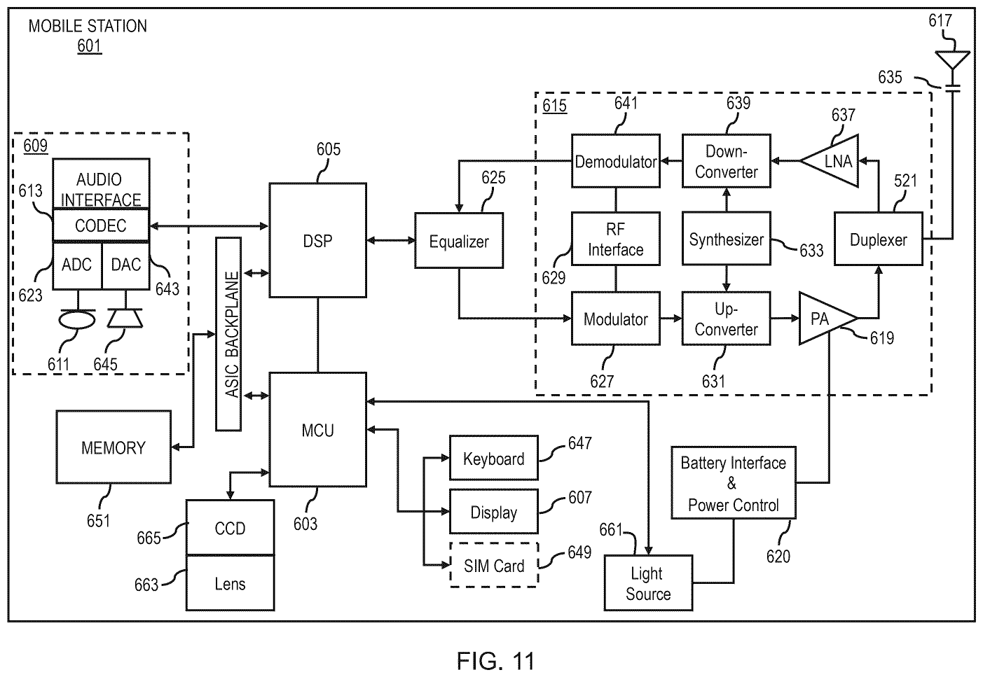

In various aspects, the controller 103 includes an operational condition detection module 105 with instructions to cause the system and controller 103 to perform one or more steps of the method 300 of FIG. 5. In some aspects, the controller 103 comprises a general purpose computer system, as depicted in FIG. 9 or a chip set as depicted in FIG. 10 or a mobile terminal as depicted in FIG. 11.

As shown in FIG. 1B, in some aspects the controller 103 is communicatively coupled with other components of the system, in order to take certain remedial action in the event of the detection of an operational condition of the labelling system. In one aspect, the controller 103 is communicatively coupled with a drive system 132 that is used to move the container carriers 101 along the travel lane 102. In some aspects, the drive system 132 includes one or more of a linear motor vehicle, a chain, a belt and a turntable. In this example aspect, upon detecting an operational condition (e.g. causing a defect in the labelling of the containers) of the labelling system, the controller 103 is configured to transmit a signal to one or more components of the drive system 132 to correct the detected operational condition. In still other aspects, the controller 103 is communicatively coupled with a display 133. In this example aspect, the display 133 is located within the labelling system such that it is viewed by one or more operators of the labelling system. In this example aspect, upon detecting an operational condition of the labelling system, the controller 103 transmits a signal to the display 133 to output data indicating the operational condition and/or recommending certain remedial action (e.g. “Containers on carrier #5 are being mislabeled, check position of carrier #5.”).

FIG. 1C depicts the position of the deformable panel 106 after being moved or deflected by the container 122d during the labelling process. For ease of illustration, the controller 103, drive system 132 and display 133 are not depicted in FIGS. 1C and 1D. As shown in FIG. 1C, in one aspect upon deflection of the deformable panel 106 by the container 122d, the detected laser signal 127b′ is received at the laser sensor 128. The controller 103 receives the data from the laser sensor 128 indicating the parameter values of the detected laser signal 127b′ and determines that the distance 146 between the deformable panel position 109 and the laser sensor 128 has reduced from the distance 144 in FIG. 1B. The distance 146 depicted in FIG. 1C is a minimum value of the distance between the deformable panel position 109 and the laser sensor 128 during the deflection of the deformable panel 106 by the container 122d. FIG. 1D then depicts the position of the deformable panel 106 after the container 122d has passed and been labeled at the deformable panel 106. The deformable panel 106 in FIG. 1D has returned to the undeflected position that was shown in FIG. 1B where the distance 144 is at a maximum value. As previously disclosed, one advantage of this arrangement of the non-contact sensor (e.g. laser sensor 128) is the ability to verify that the deformable panel 106 has returned to the same position in FIG. 1D after the labelling of the container 122d as the initial position in FIG. 1B prior to the labelling of the container 122d.

A displacement is calculated based on a change in the measured distance between the deformable panel position 109 and the laser sensor 128 during the application of the label 120 to the container 122d. In one aspect, the controller 103 calculates the displacement based on a difference between the distance 144 and the distance 146. However, in these aspects the controller 103 does not just calculate the displacement at the end of the labelling process, but at regular time increments throughout the labelling process (e.g. at various positions of the deformable panel 106 between FIGS. 1B and 1C as well as between FIGS. 1C and 1D). This continuous variation of the displacement during the labelling of each container is defined as a “distance profile”.

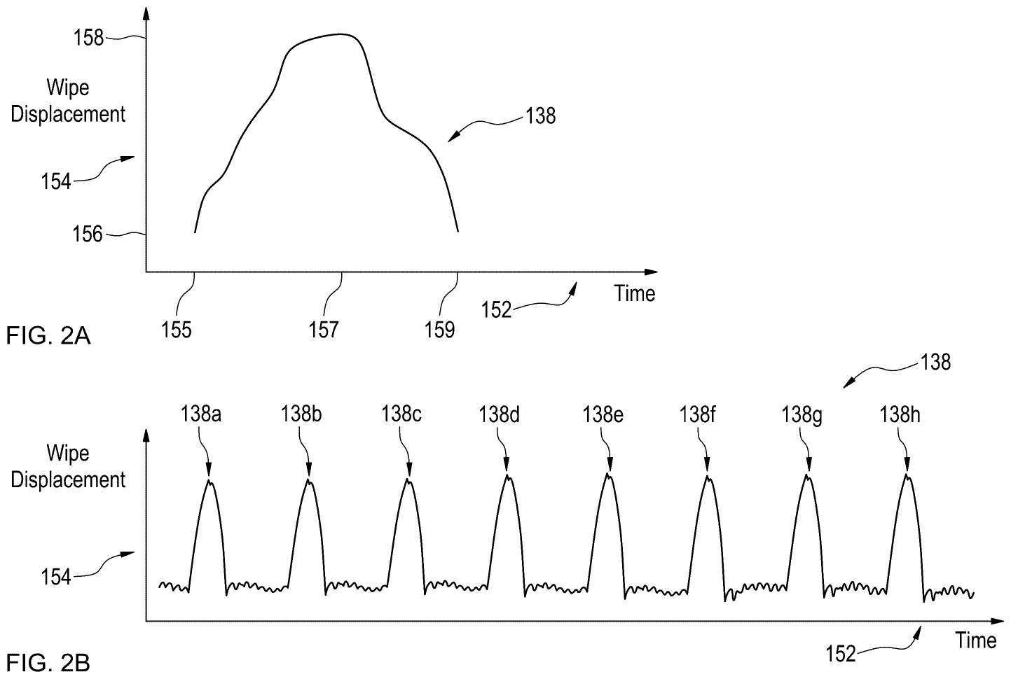

One example of a distance profile will now be discussed. FIG. 2A is an example according to various aspects illustrating a graph with a distance profile 138 indicating a displacement of the deformable panel 106 between FIGS. 1B and 1D. The horizontal axis 152 is time (arbitrary units) and the vertical axis 154 is displacement (arbitrary units). “Displacement” herein is defined as a difference between an initial distance 144 (FIG. 1B) at the beginning of a wipe event or labelling event and a subsequent distance (e.g. distance 146 in FIG. 1C) at a later time in the wipe or labelling event. As shown in FIG. 2A, at an initial time 155, the displacement 156 has a minimum value, since at the initial time 155 (e.g. FIG. 1B) the deformable panel 106 has not yet displaced from the initial undeflected position. As shown in FIG. 1D, at a subsequent time 157 the displacement 158 has a maximum value, since at the subsequent time 157 (e.g. FIG. 1C) the deformable panel 106 has displaced by a maximum value from the initial undeflected position. In this example aspect, the maximum displacement 158 is the difference between the initial distance 144 (FIG. 1B) and the subsequent distance 146 (FIG. 1C). At the final time 159 the displacement 156 returns to the minimum value since at the final time 159 (FIG. 1D) the deformable panel 106 has returned to the undeflected position and thus there is no displacement.

In various aspects, the apparatus 100 measures and records a distance profile for each labelling event of each container. In some aspects, this distance profile is then used in a comparative manner. If two distance profiles are (near) identical, it is inferred that the labelling process for both containers has been the same, and therefore with high confidence also the output quality is the same. In other aspects, the distance profiles can be overlayed to reveal different issues. In one example aspect, the overlayed distance profiles form a continuous succession of distance profiles can indicate overall process variability. In another example aspect, the overlayed distance profiles of two different apparatuses 100 of the same machine or from different machines can indicate whether the different apparatuses 100 or different machines are performing similarly. In still another example aspect, distance profiles can be overlayed from different time ranges to indicate whether the labelling process is presently performing similarly as it was performing at an earlier time period. In still other aspects of the disclosure, there could also be a comparison versus a reference graph as it was originally created upon process qualification to match ideal labelling conditions and output.

In other aspects, the disclosure herein includes a useful extension to infer specific machine or process conditions from the distance profiles. In one example aspect, an operational condition of the labelling system can be automatically determined from the distance profiles and/or certain remedial action can be automatically performed to correct this operational condition. In one example aspect, the memory 111 of the controller 103 could include a database of reference distance profiles associated with known explanations of optimal or sub-optimal operational conditions and/or remedial action (e.g. “distance profile x is associated with good quality product”, “distance profile y is associated with improper orientation of the container relative to the deformable panel”) that can be used to optimize the process more quickly. In yet another example aspect, the memory 111 of the controller 103 could include a database of reference distance profiles associated with known explanations of optima or sub-optimal operational conditions for a variety of container, e.g. bottles, tubs and the like.

FIG. 2B is an example according to various aspects illustrating a graph with a plurality of distance profiles 138 indicating displacement of the deformable panel 106 of FIG. 1A due to the plurality of containers 122a through 122d. It should be noted that the distance profiles 138 may have different characteristics, which indicates a potential operational condition of the labelling system to be investigated and/or remedied. For example, the distance profile 138c is noticeably different from the other distance profiles 138 since it takes longer for the distance profile to reach the maximum value. This may or may not indicate an operational condition associated with the container 122b. In one example aspect, the container 122b may be positioned too far away from the deformable panel 106 which then caused the deformable panel 106 to not displace as much during the labelling event of the container 122b.

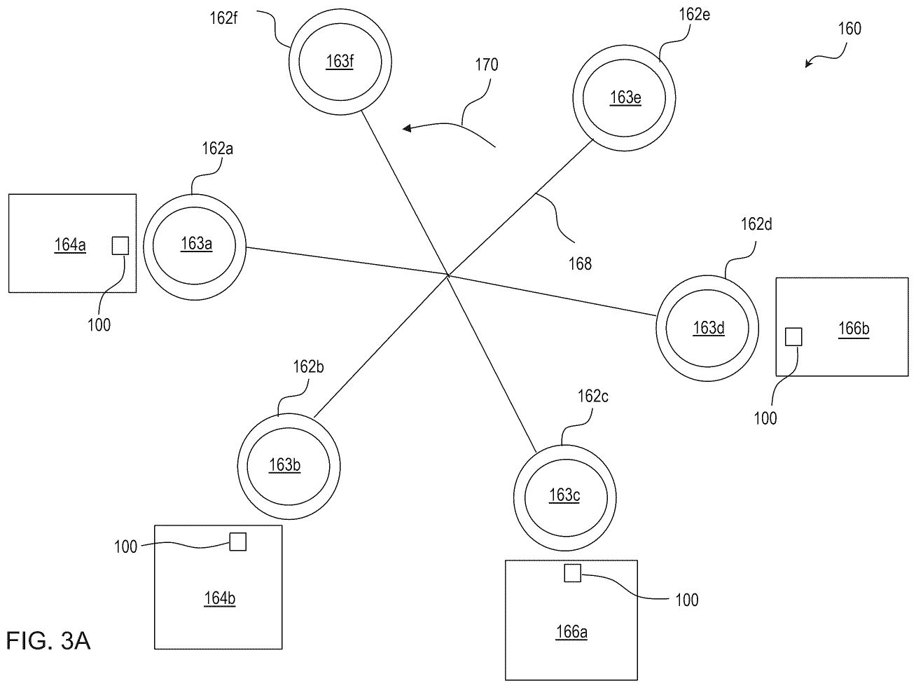

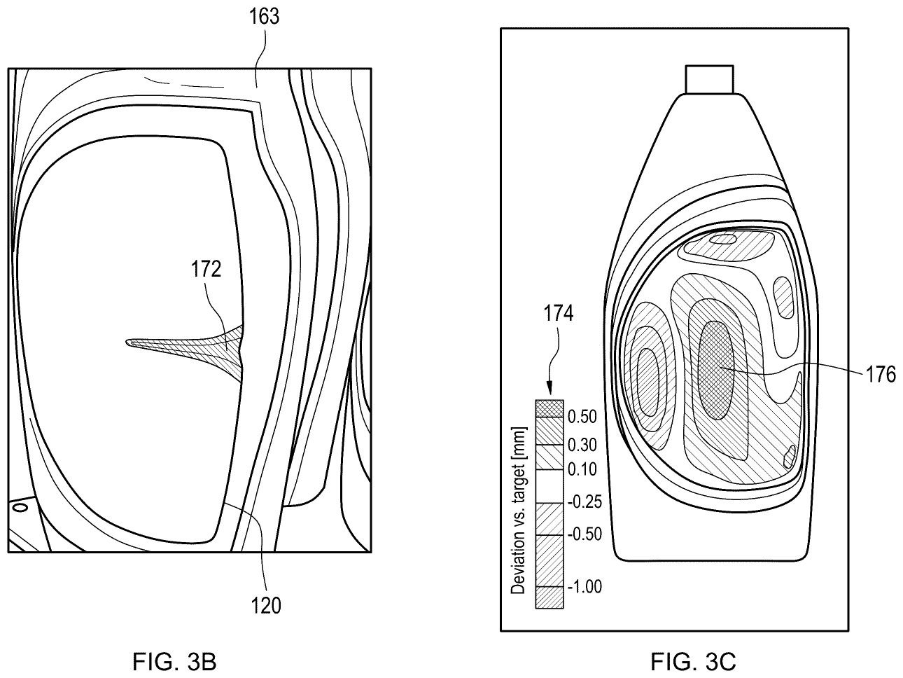

Although FIGS. 1A through 1D depict the apparatus 100 with containers 122 and container carriers 101 traveling in a linear travel lane 102, the disclosure herein is not limited to this arrangement and also includes an apparatus where the containers and container carriers travel in an arcuate, serpentine or circular path. FIG. 3A is an example according to various aspects illustrating a block diagram of a system 160 for the labelling of containers on container carriers that move in a circular travel lane 170. In one aspect, the containers are bottles 163 and the container carriers are plates 162. In one example aspect, the system 160 (without the apparatus 100) is similar to the Modular SL® manufactured by P.E. Labellers® (Cincinnati, Ohio). In other aspects, each of the container carriers also includes a neck holder in registration with the plates 162. In this example aspect, each of the bottles 163 is held by the neck holder of each plate 162. An interior pressure of each bottle 163 may be applied by the neck holder of the respective plate 162.

As further shown in FIG. 3A, in an aspect the system 160 includes a turret 168 of the drive system 132 and causes the bottles 163a through 163f to rotate past on a number of labelling heads (164a, 164b) (166a, 166b). Each labelling head (164a, 164b) (166a, 166b) features the apparatus 100. A pair of front labelling heads 164a, 164b are provided to label a front side of each bottle 163 as it passes the front labelling heads 164a, 164b. Only one of the front labelling heads 164a, 164b is operational at a time and thus the other front labelling head is provided as a backup labelling head in the event that the other labelling head ceases to be operational. A pair of back labelling heads 166a, 166b are provided to label a back side of each bottle 163 as it passes the back labelling heads 166a, 166b. As with the pair of front labelling heads 164a, 164b only one of the back labelling heads 166a, 166b is operational at a given time. A motor (not shown) of the drive system 132 pivots each bottle 163 between the front labelling heads 164a, 164b and the back labelling heads 166a, 166b so that the back side of each bottle 163 is facing the back labelling heads 166a, 166b. Although six plates holding six bottles is depicted in FIG. 3A, in other aspects less or more than six plates and bottles can be provided in the system 160.

One example of a defect in the labelling of the bottles will now be discussed. FIG. 3B is an example according to various aspects illustrating an image of a label 120 with a wrinkle 172 applied to a bottle 163 using the apparatus 100 of FIG. 3A. As appreciated by one of ordinary skill in the art, the bottle 163 geometry varies from bottle to bottle. In some aspects, during the application of the label 120 to the bottle 163 air gets trapped leading to subsequent wrinkles 172 and/or other nonuniformities. Although bottles 163 typically have a cylindrical curvature, when they are formed (e.g. blowing) they routinely have imperfections and thus have local peaks and valleys and thus not true cylindrical surfaces. Although the material of the label 120 is designed to compensate for these surface variations by being stretchable, if the surface variations are too much then the label 120 is compressed locally and will attempt to release this compression by peeling off, resulting in the wrinkle 172.

It was discovered that since there are multiple (e.g. about 20) parameters of the labelling system that affect the quality of the labelling of the bottle 163, the existence of the wrinkle 172 cannot necessarily be traced down to a parameter of the bottle 163 (e.g. surface variations, internal pressure, etc.) and may be traced down to a parameter of the system. In one example aspect, if a wrinkle 172 is observed in each bottle 163 on the plate 162a, then it should be investigated whether a parameter of the plate 162a is responsible for the wrinkle 172. Another factor to consider is that some of the defects (e.g. wrinkle 172) may not appear for a noticeable time (e.g. 24 to 48 hours) after the labelling event and thus the disclosure herein advantageously determines what operational parameters cause these defects prior to the labelling process so to minimize the occurrence of these defects after the labelling event. A subset of important parameters is given in Table 1 below. Depending on the nature of the product being labeled (its shape, size rigidity, etc.), the label (adhesive, laminate structure, shape, size, etc.) and the process setup (direction of travel, speed) and variabilities present the interaction between them and the limits that yield optimal output quality can be difficult to grasp fully. Experiments can be conducted physically or virtually through means of first-principle models to determine appropriate configurations.

TABLE 1

| Parameter | Example range |
|---|---|
| Wipe Penetration | 20-40 mm |
| Beak Z-Angle Relative | 5-40 degrees |
| to Turret Tangent | |
| Internal bottle pressure | 0-14 kPa |
| Turret Height | 1-10 mm less than |
| | bottle height |
| Wipe construction | Plate 2 present: |
| Rubber dimensions | 30-70 mm width, −10 |
| Metal plates 1-2 | to +10 mm vs label |
| dimensions | height |
| | 0.2-0.8 mm thick |
| | Plate 1 present: 60-140 |
| | mm width, −10 to +10 |
| | mm vs label height |
| | 0.2-0.8 mm thick |
| | Rubber wipe: 2 to 10 |
| | mm higher than label, |
| | 5-20 mm longer than |
| | Plate 1 |
| | 0.5-2 mm thick |

In one aspect of the disclosure, Table 1 above lists a wipe penetration parameter. This wipe penetration parameter 151 is depicted in FIG. 1E and is defined as a spacing between the free end 108 of the panel 106 and a tip of the peeler bar 112, as measured along the panel 106. In one example aspect of the disclosure, the wipe penetration parameter 151 has a desired value range from about 20 millimeters (mm) to about 40 mm. However, in other example aspects of the disclosure, the wipe penetration parameter 151 can have a desired value range outside this range. In some example aspects, after the value of the wipe penetration parameter 151 is adjusted so that a desired labelling of the containers is achieved, the distance profile 138 is measured and stored in the memory 111 of the controller 103. This stored distance profile is then compared with subsequently measured distance profiles during the labelling process and if a deviation is detected then this parameter can be inspected to ensure it is within the desired value range. It should be noted that the desired value range for the wipe penetration parameter 151 may depend on various characteristics of the apparatus, such as the type of container 122, the size of the container 122, etc. As further shown in FIG. 1E, another parameter of the apparatus includes a spacing 153 between the panel 106 and the tip of the peeler bar 112. In an example aspect, the desired value of the spacing 153 is about 2 mm.

In another aspect of the disclosure, Table 1 above lists a beak Z-angle relative to a turret tangent. In one aspect of the disclosure, this angle 180 is depicted in FIGS. 1C and 1s measured between a direction of the peeler bar 112 and the downstream direction 104 in which the container 122 travels at the point of the peeler bar 112 and/or panel 106. In the example aspect of FIG. 3A, the angle 180 is measured between the direction of the peeler bar 112 and a tangent direction of the turret 168 at the respective peeler bar 112 and/or panel 106. This is due to the downstream direction 104 having an arcuate shape in FIG. 3A and thus the tangent to the turret 168 at each peeler bar 112 and panel 106 is used to measure the angle 180 with the peeler bar 112 direction. In an example aspect, the angle 180 has a desired value range from about 5 degrees to about 40 degrees. However, in other aspects the angle 180 could have a value beyond this range. As appreciated by one of ordinary skill in the art, the desired value range of the angle 180 would depend on certain features, such as features of the container 122. In some example aspects, after the value of the angle 180 is adjusted so that a desired labelling of the containers is achieved, the distance profile 138 is measured and stored in the memory 111 of the controller 103. This stored distance profile is then compared with subsequently measured distance profiles during the labelling process and if a deviation is detected then this parameter can be inspected to ensure it is within the desired value range.

In another aspect of the disclosure, Table 1 above lists the internal pressure of the container 122 as a parameter. In an example aspect of the disclosure, the internal pressure of the container 122 should be within a desired value range between about 0 kPa and 14 kPa. However, in other aspects the desired value range may include values outside this range. In some example aspects, after the value of the internal pressure of the container 122 is adjusted so that a desired labelling of the containers is achieved, the distance profile 138 is measured and stored in the memory 111 of the controller 103. This stored distance profile is then compared with subsequently measured distance profiles during the labelling process and if a deviation is detected then this parameter can be inspected to ensure it is within the desired value range.

In another aspect of the disclosure, Table 1 above lists turret height as a parameter. In an example aspect of the disclosure, the turret height indicates a height of a top plate (not shown) that presses on a top of the container 122 (or bottle 163) to ensure that it stays on the carrier 101 or plate 162 during the labelling process. The top plate should be adjusted to a height so that it applies adequate downward pressure on the top of the container 122 to ensure the container 122 (or bottle 163) remains on the carrier 101 or plate 162 during the labelling process but not too much pressure so as to cause the container 122 or bottle 163 to buckle. Thus, the desired value of the turret height is set in a desired value range from about 1 mm to about 10 mm lower than the container 122 or bottle 163 height. In an example aspect, the top plate (not shown) includes a spring and thus the turret height of between about 1 mm to about 10 mm lower than the bottle height indicates the position of the spring in the neutral position which is then compressed upward by the container or bottle. In some example aspects, after the value of the turret height is adjusted so that a desired labelling of the containers is achieved, the distance profile 138 is measured and stored in the memory 111 of the controller 103. This stored distance profile is then compared with subsequently measured distance profiles during the labelling process and if a deviation is detected then this parameter can be inspected to ensure it is within the desired value range.

In another aspect of the disclosure, Table 1 above lists various dimensions of plates mounted to a back of the panel 106 as a parameter. FIG. 1F depicts an example aspect of these dimensions of a first plate 165 and a second plate 161 mounted to the back of the panel 106. These plates 165, 161 are made from rigid material (e.g. metal) to ensure that the panel 106 applies adequate pressure during the labelling process. In an example aspect, the panel 106 is made from rubber material and thus without these metal plates 161, 165 mounted to the back of the panel 106, the rubber panel 106 would simply flop around during the labelling process and not generate the necessary pressure to apply the label 120 to the container 122. As shown in FIG. 1F the second plate 161 has a width 167 with a desired value range between about 30 mm and about 70 mm; the second plate 161 also has a height 188 that is differs from the label 120 height by a range between −10 mm and +10 mm. The second plate 161 has a thickness (not shown) between about 0.2 mm and about 0.8 mm. As further shown in FIG. 1F, the first plate 165 has a width 169 with a desired value range between about 60 mm and 140 mm; the first plate 165 also has a height 188 that differs from the label 120 height by a range between −10 mm and +10 mm. The first plate 165 has a thickness (not shown)_between about 0.2 mm and about 0.8 mm. The panel 106 has a height that is higher than the label 120 by a range between about 2 mm and 10 mm. The panel 106 also has a width that differs by a spacing 191 with the first plate width 169, where the spacing 191 is in a desired value range from about 5 mm to about 20 mm. The panel 106 has a thickness (not shown) that is in a desired value range from about 0.5 mm to about 2 mm. It should be noted that the numerical values of the desired ranges of the parameters herein are merely one example numerical value range and the desired value range for each parameter can be outside these numerical value ranges. In some aspects, the desired value range for each parameter is based on other characteristics of the system (e.g. size of the container, pressure of the container, etc) and thus can be outside these example ranges depending on these other characteristics. In some example aspects, after the value of one or more of these parameters of the plates 161, 165 is adjusted so that a desired labelling of the containers is achieved, the distance profile 138 is measured and stored in the memory 111 of the controller 103. This stored distance profile is then compared with subsequently measured distance profiles during the labelling process and if a deviation is detected then this parameter can be inspected to ensure it is within the desired value range.

FIG. 3C is an example according to various aspects illustrating an image of the label 120 on the bottle 163 of FIG. 3B using a spectrum 174 to depict surface 176 imperfections. In one aspect of the disclosure, the spectrum of the surface 176 imperfections shows if the bottle 163 is under tension or compression. It was recognized that if certain stresses build up in the surface 176 during the labelling process, then those stresses slowly release over time (e.g. 24 to 48 hours) and thus cause the wrinkle 172. Thus, the aspects of the disclosure herein were developed in an effort to determine what specific parameters of the labelling process are responsible for these stresses so to prevent them from occurring during the labelling process and thus minimizing the instance of defects such as the wrinkles 172.

The type of material that comprises the container (e.g. bottle 163) will now be discussed. In one aspect, the container is made from at least one of: an elastomeric material; a material having a Young's modulus between 3 MPa and 150 MPa measured according to ISO 527-1:2012; and a material having a Shore A hardness from 0 to 80 according to ISO 868:2003. In other aspects, the container is a resiliently squeezable container that may be made from an elastomeric material (silicone, thermoplastic elastomer, etc.). In this example aspect, a resiliently squeezable container may be made from a material having a Young's modulus comprised between 3 MPa and 150 MPa, preferably between 3.6 MPa and 120 MPa as measured according to ISO 527-1:2012. In still other aspects, the resiliently squeezable container may be made from a material having a Shore A (Type A) hardness of from 0 to 80, preferably 5 to 60, more preferably 10 to 40 as measured according to ISO 868:2003. In still other aspects, the container may be made from a rigid material. An example aspect of such rigid materials include at least one of: polyethylene, polypropylene, polyethylene terephthalate, acrylonitrile butadiene styrene, preferably polyethylene or polypropylene, more preferably polypropylene. Such materials having a Young's modulus comprised between 0.25 GPa and 4 GPa, preferably between 0.5 GPa and 3.5 GPa as measured according to ISO 527-1:2012. Such materials having a Shore D hardness comprised between 30 and 100, preferably between 55 and 100, more preferably between 65 and 95 as measured according to ISO 868:2003.

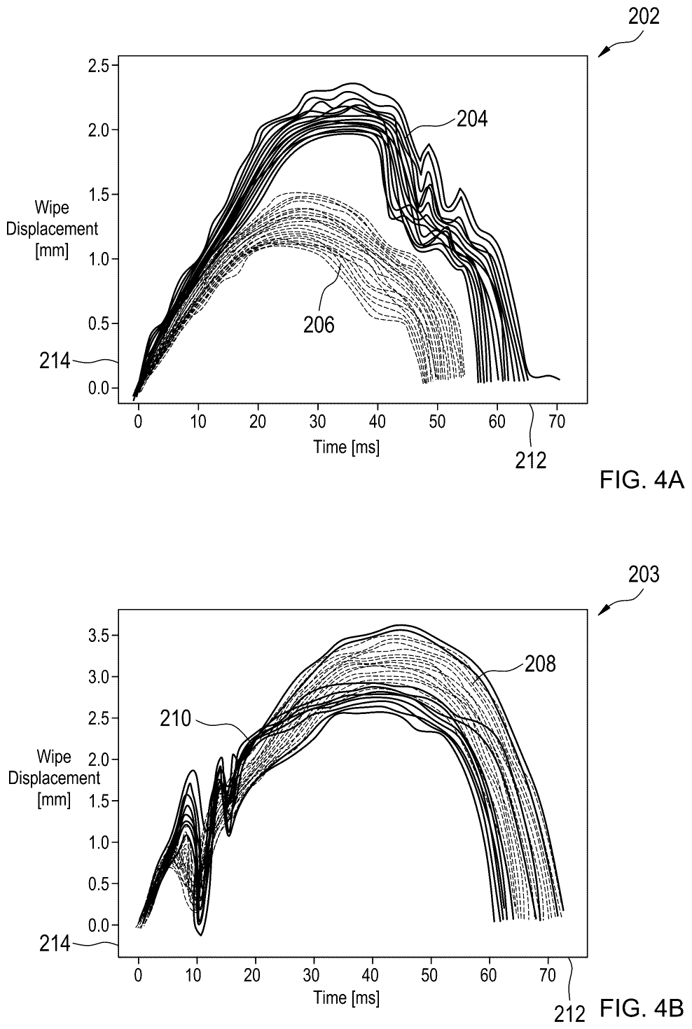

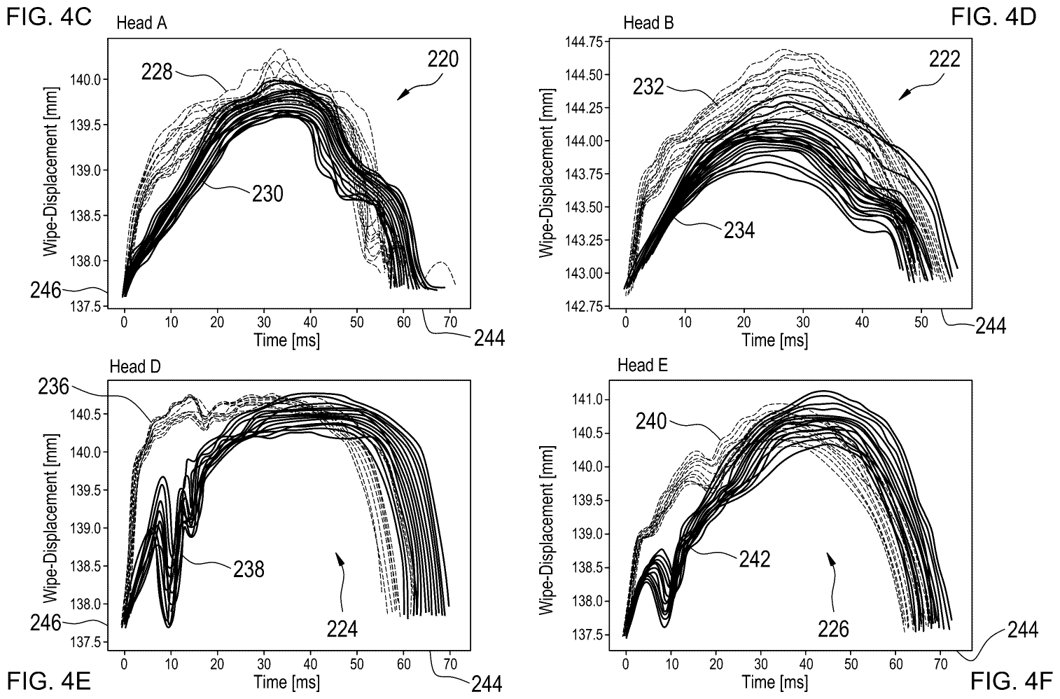

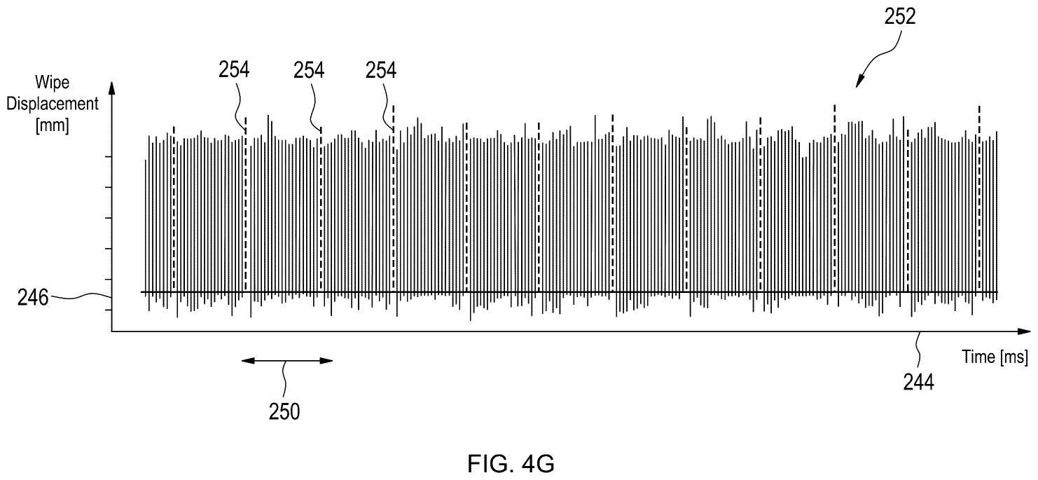

Distance profile arrays generated with the front and back labelling heads of FIG. 3A are now discussed. FIG. 4A is an example according to various aspects illustrating a graph 202 with distance profile arrays 204, 206 for the front labelling heads 164a, 164b of FIG. 3A. It is worth noting that distance profile arrays 204, 206 may be created regardless of whether the container carriers travel in a circular path, linear path, serpentine path, arcuate path, etc. The horizontal axis 212 is time (arbitrary units) and the vertical axis 214 is displacement (in units of millimeters or mm). Based on viewing the distance profile arrays 204, 206, it is observed that the front labelling heads 164a, 164b have visibly different distance profiles. The first front labelling head 164a wiping process takes longer, and the deformable panel 106 is deflected more. From the distance profile arrays 204, 206 alone, it cannot be concluded which head 164a, 164b is better. However, understanding and eliminating these differences will overall result in a more robust process. Additionally, the distance profile arrays 204, 206 clearly indicate that the maximum displacement of the front labelling head 164a is much bigger than the maximum displacement of the front labelling heads 164b. In some aspects of the disclosure, the distance profile arrays 204, 206 are analyzed using the method disclosed herein in order to determine any operational condition that may be responsible for the variation in the distance profile arrays 204, 206. Determining the operational condition and/or taking remedial action to resolve the operational condition advantageously eliminates this noticeable difference between the distance profile arrays 204, 206 in order to reduce variability introduced into the labelling process.

FIG. 4B is an example according to various aspects illustrating a graph 203 with distance profile arrays 208, 210 for the back labelling heads 166a, 166b of FIG. 3A. As shown in FIG. 4B, the back labelling heads 166a, 166b show very similar distance profiles, indicating that the total setup is behaving near identical. Thus, similar quality output can be expected from both back labelling heads 166a, 166b. Additionally, the distance profile arrays 208, 210 clearly indicate that the maximum displacement of the back labelling heads 166a, 166b is very similar.

Distance profile arrays generated with each of the labelling heads of FIG. 3A are now discussed. FIGS. 4C through 4F are examples according to various aspects illustrating a respective graph with a respective distance profile array for each respective head of FIG. 3A. The horizontal axis 244 is time in units of seconds and the vertical axis 246 is displacement in units of mm. In one aspect, the graph 220 of FIG. 4C depicts the distance profile array 228, 230 for head 164a, where the distance profile array 230 includes a large majority of the distance profiles and the distance profile array 228 shows outliers. In one aspect, the graph 222 of FIG. 4D depicts the distance profile array 232, 234 for head 164b, where the distance profile array 234 includes a large majority of the distance profiles and the distance profile array 232 shows outliers. In one aspect, the graph 224 of FIG. 4E depicts the distance profile array 236, 238 for head 166a, where the distance profile array 238 includes a large majority of the distance profiles and the distance profile array 236 shows outliers. In one aspect, the graph 226 of FIG. 4F depicts the distance profile array 240, 242 for head 166b, where the distance profile array 242 includes a large majority of the distance profiles and the distance profile array 240 shows outliers. As shown in FIG. 4C, for the front labelling head 164a, the distance profile arrays 228, 230 are tightly packed together, compared to the front labelling head 164b (FIG. 4D). This indicates that there is a larger spread or variation in the distance profiles recorded by the front labelling head 164b and thus may indicate an operational condition associated with the head 164b (e.g. the mechanical mount of the front labelling head 164b requires adjustment, etc.).

FIG. 4G is an example according to various aspects illustrating a graph with a plurality distance profiles 252 indicating displacement of one of the heads 164b of FIG. 3A. As shown in FIG. 4G, the distance profiles 252 generated by the head 164b over time indicates an anomalous signal 254 that occurs at a fixed frequency of every 20^{th} signal. In the event that the system 160 includes twenty heads, this may indicate an issue with one of the plates, such as plate 162f, which coincides with each anomalous signal. In these aspects, there may be an operational condition with the plate 162f and thus this plate 162f may require remedial action (e.g. adjusting a position of the plate 162f relative to the heads 164, 166; adjusting a servo motor that rotates the plate 162f between the heads 164a, 164b and the heads 166a, 166b, etc.).

### Method for Detecting an Operational Condition of the Apparatus

FIG. 5 is an example according to various aspects illustrating a flow chart depicting steps of a method 300 for detecting an operational condition of the apparatus 100 of FIG. 1A. Although steps are shown in FIG. 5 as integral blocks in a particular order, in other aspects, one or more steps or portions thereof are performed in a different order or overlapping in time, in series or in parallel, or are omitted or one more additional steps are added.

In step 302, a plurality of containers are engaged with a respective plurality of container carriers. In one aspect, in step 302 the containers 122a through 122d are engaged with the respective plurality of container carriers 101a through 101d. However, less or more than four containers and container carriers can be provided. In other aspects, in step 302 the bottles 163 are engaged with the plates 162.

In step 304, the container carriers and container engaged therewith are conveyed past a deformable panel of the apparatus. In some aspects, in step 304 the container carriers 101 and the containers 122 are conveyed along the travel lane 102 (e.g. linear travel lane 102) past the deformable panel 106. In other aspects, in step 304 the container carriers (e.g. plates 162) and the containers (e.g. bottles 163) are conveyed in a curved or circular travel lane 170 based a plurality of heads 164a, 164b, 166a, 166b which each include the deformable panel 106 to apply the label 120 to the bottle 163 on each plate 162. In one aspect, in step 304 the controller 103 transmits one or more signals to the drive system 132 to cause the conveyance of the container carriers and the containers past the deformable panel.

In step 306, a distance is measured from the displacement sensor to the deformable panel as each container carrier is conveyed past the deformable panel to generate a distance profile. In some aspects, in step 306 the distance 144, 146 (FIGS. 1B through 1D) is measured from the laser sensor 128 of the displacement sensor 110 to the fixed position 109 on the deformable panel 106. This results in the distance profile 138 for each wiping event or labelling event of each container in both the apparatus 100 of FIGS. 1A through 1D and the system 160 of FIG. 3A. In one example aspect, the laser sensor 128 measures displacement of the deformable panel 160 during labelling of the container at a high sampling rate (e.g. about 1 kHz). In one example aspect, in step 306 the controller 103 receives data from the laser sensor 128 at each time increment and calculates the displacement at each time increment based on a difference between the initial distance 144 at the beginning of the labelling or wiping event and the distance (e.g. distance 146) at a later time in the labelling or wiping event.

In step 308, each distance profile generated in step 306 is associated with a unique container carrier. As appreciated by one skilled in the art, a control signal is transmitted to the drive system 132 (e.g. turret 168) from the controller 103 to cause the movement of the plates 162 past each labelling head 164a, 164b, 166a, 166b. In one aspect, in step 308 the controller 103 synchronizes this control signal with the distance profiles generated by each labelling head 164a, 164b, 166a, 166b in order to identify or associate each generated distance profile with one of the plates 162. A similar step can be performed in the apparatus 100 of FIG. 1A where the container carriers 101 move in the linear travel lane 102 in order to associate each distance profile with one of the container carriers 101. In an example aspect, in step 308 a raw data stream of distance profiles (e.g. FIG. 2B, 4G) is processed to extract the individual distance profiles that correspond to individual labelling events.

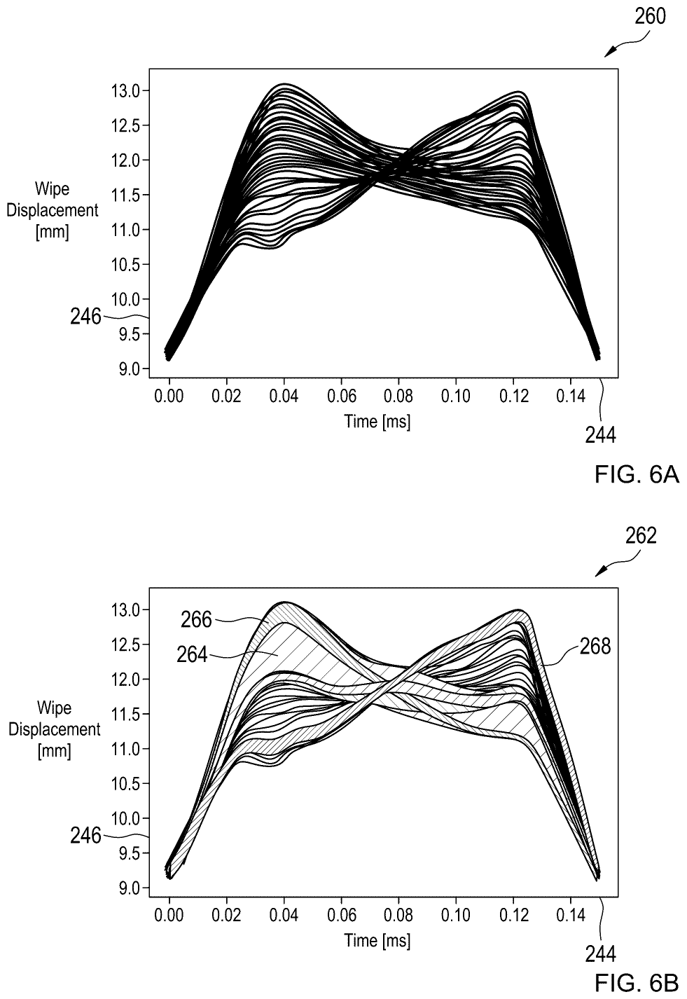

In step 310, each distance profile from step 308 that is associated with a unique container carrier is recorded in a distance profile array. As shown in FIGS. 4C through 4F, step 310 results in each of the distance profile arrays in FIGS. 4C through 4F for each of the respective labelling heads 164a, 164b, 166a, 166b. In another aspect, FIG. 6A depicts a distance profile array 260 that is generated in step 310. In one example aspect, in step 310 the distance profiles from step 308 are overlayed by the controller 103 which generates the distance profile array. In some aspects, in step 310 a clustering analysis is performed on the distance profile array by the controller 103 which can result in one or more clusters in the distance profile array that may correspond to one or more unique container carriers. In this example aspect, FIG. 6B depicts a clustered distance profile array 262 which includes a first cluster 264 that corresponds to a vast majority of the distance profiles and a second and third cluster 266, 268 which correspond to a minority of the distance profiles. In an example aspect, the second and third cluster 266, 268 may each correspond to a unique container carriers (e.g. plate 162b for the second cluster 266 and plate 162c for the third cluster 268). This indicates that an operational condition associated with these unique container carriers may be responsible for the deviation in the second and third clusters 266, 268 from the first cluster 264. Hence, this advantageously facilitates narrowing down the assessment to these unique container carriers and taking any remedial action which may resolve this deviation in the distance profiles. In one example aspect, a clustering algorithm may be used to perform the clustering analysis in step 310, to generate the clustered distance profile array such as Scikitlearn DBSCAN® (https://scikit-learn.org/stable/auto_examples/cluster/plot_cluster_comparison.html).

In one aspect, the distance profile array recorded in step 310 can be for all plates 162 recorded at a single head 164a, 164b, 166a, 166b. Subsequent steps of the method 300 based on this generated distance profile array may indicate an operational condition associated with one or more of the plates 162 which can then be remedied through various active steps. In another aspect, the distance profile array recorded in step 310 can be for all heads 164a, 164b, 166a, 166b that generate distance profiles for the same plate 162. Subsequent steps of the method 300 based on this generated distance profile array may indicate an operational condition associated with one or more of the heads that can then be remedied through various active steps.

In step 312, a deviation is determined between one or more distance profiles in the distance profile array generated in step 310. In one aspect, the deviation is based on a deviation between the clusters 264, 266, 268 in the distance profile array determined in step 310. In other aspects, the deviation is based on a deviation between one of the distance profiles and a mean or average of the remaining distance profiles. In one example aspect, the deviation determined in step 312 is compared with a threshold value that is stored in the memory 111 of the controller 103. In one example aspect, the threshold value could be ±10% of the average profile amplitude and/or ±5 standard deviations from the average signal, evaluated over the length of the signal. In one example aspect, the deviation determined in step 312 is determined based on Euclidean distance between the profiles. In one example aspect, the distance profiles are transformed to a lower dimensional representation before calculating the deviation in order to speed up the calculation or reduce unwanted noise. In one example aspect, dimensionality reduction is performed with the software package Scikitlearn PCA® (https://scikit-learn.org/stable/modules/generated/sklearn.decomposition.PCA.html). In one example aspect, the deviation determined in step 312 is determined by decision tree classification. In one example aspect, a decision tree classification software package used in step 312 is Scikitlearn Isolation Forest (https://scikit-learn.org/stable/modules/generated/sklearn.ensemble.IsolationForest.html).

In step 314, the determined deviation from step 312 is compared with the stored threshold value. If the determination in step 314 is in the affirmative, then the method proceeds to step 316, otherwise the method ends.

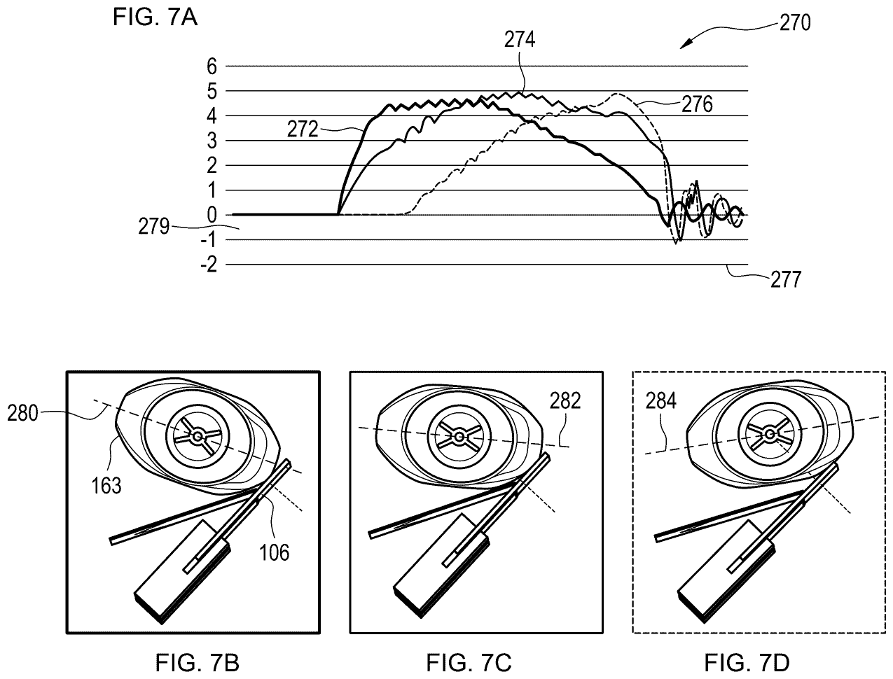

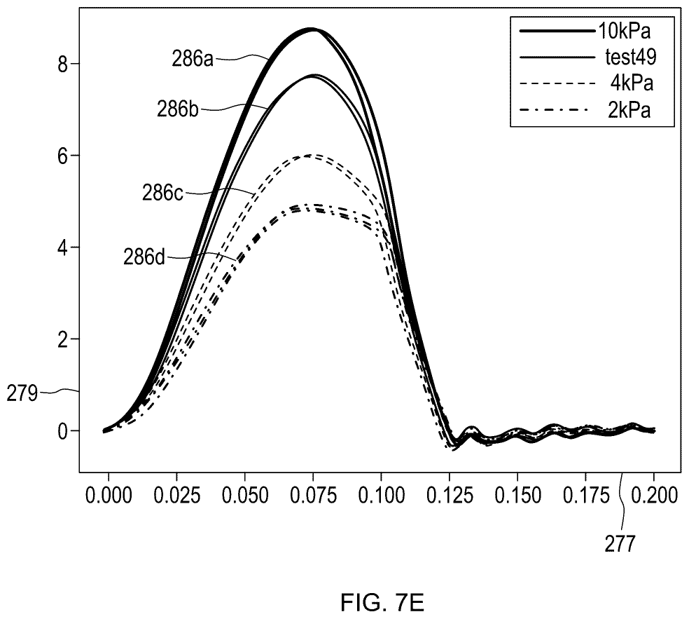

In step 316, each distance profile from the distance profile array of step 312 having the deviation is compared with a plurality of stored distance profiles that are associated with a plurality of known operational conditions. FIG. 7A is an example according to various aspects illustrating a graph 270 with distance profiles 272, 274, 276 indicating a simulated displacement of the deformable panel 106 based on respective operational conditions of the apparatus 100 of FIG. 1A. The horizontal axis 277 is time (arbitrary units) and the vertical axis 279 is displacement (in units of mm). FIGS. 7B through 7D are examples according to various aspects illustrating different operational conditions in the simulated displacement of each distance profile 272, 274, 276 in FIG. 7A. Specifically, FIGS. 7B through 7D depict different orientations 280, 282, 284 of the bottle 163 incident on the deformable panel 106. In one example aspect, the orientation of the bottle is varied by incremental amounts (e.g. −20 degrees, −10 degrees, +10 degrees, +20 degrees, etc.). The respective distance profiles 272, 274, 276 are then generated by the simulation software. These distance profiles 272, 274, 276 are then stored in the memory 111 of the controller 103 along with their respective parameter values of the labelling system (e.g. orientation angle value of the bottle 163). In one aspect, in step 316 if the controller 103 determines that one of the distance profiles with the deviation is the same or substantially similar to one of the stored distance profiles 272, 274, 276 in the memory 111, the controller 103 can determine that the operational condition associated with the matched simulated distance profile 272, 274, 276 may have caused the distance profile with the deviation.

In some aspects, numerous parameters (e.g. twenty) of the labelling process can affect the quality of the labelling process. In one aspect, for each of these numerous parameters, a value of the parameter is selected which may cause an operational condition that affects the labelling of the container. For each selected parameter value, the simulation software is used to generate a simulated distance profile which is then stored in the memory 111 along with the parameter value (e.g. “bottle 163 aligned at +10 degrees”) and a remedial action to resolve the operational conditional associated with the parameter value (e.g. “adjust bottle alignment to +5 degrees”). Then during step 316, the controller 103 compares each distance profile having the deviation exceeding the threshold with each of the stored simulated distance profiles that are associated with known parameter values and a known operational condition. The controller 103 then determines a potential operational condition associated with the distance profile having the deviation based on the comparison of the distance profile with the stored simulated distance profiles. The controller 103 also determines the remedial action to resolve the operational condition, which may be also stored in the memory 111 along with the simulated distance profile and the parameter value of the labelling system. In one example aspect, a simulation software package used in step 316 is Dassault Systems Simulia Abaqus FEA® 2019.

FIG. 7E is an example according to various aspects illustrating graphs with distance profiles 286a, 286b, 286c, 286d indicating simulated displacement of the deformable panel based on various operational conditions of the apparatus. In one aspect, the distance profile 286a is a simulated displacement based on a high pressure (e.g. 10 kPa) of the container. In another aspect, the distance profile 286b is a simulated displacement based on a base condition. In one aspect, the distance profile 286c is a simulated displacement based on a low pressure (e.g. 4 kPa) of the container. In one aspect, the distance profile 286d is a simulated displacement based on a low pressure (e.g. 2 kPa) of the container.

Although in some aspects, the stored distance profiles are generated based on a simulation of the labelling or wiping events, in other aspects the stored distance profiles are generated based on experimental data of performing the labelling event or wiping event using certain known parameter values that can affect the labelling process and then storing the resulting distance profile in the memory 111 along with the known parameter values and/or operational condition that affects the labelling process.

In step 318, an action is performed based on the comparison in step 316 to address the operational condition associated with each distance profile. In some aspects, in step 318 the action performed is the controller 103 transmitting a signal to the display 133 to output data that indicates the operational condition and/or recommends remedial action to resolve the operational condition (e.g. bottle 163 on plate 162f is misaligned by −5 degrees, correct alignment). In other aspects, in step 318 the action performed is the controller 103 transmitting a signal to one of the components of the system to automatically correct the system parameter responsible for the operational condition (e.g. transmits a signal the drive system 132 and/or to the servo motor to properly align the plate 162f).

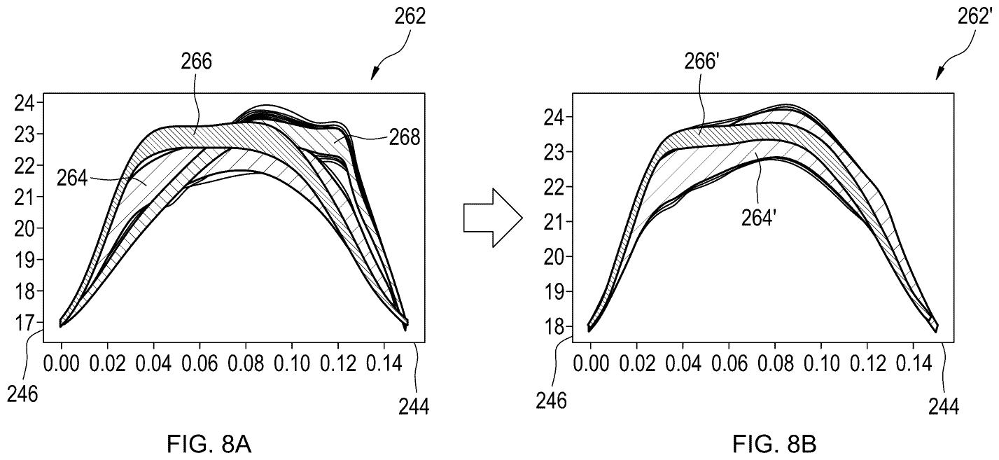

In some aspects, after step 318 the method 300 moves back to step 304 and repeats steps 304 through 314. If the previously determined deviation in step 314 is no longer above the threshold, then the operational condition associated with the labelling process has been resolved and the method ends. FIGS. 8A and 8B depict the clustered distance profile array 262 (prior to step 318) and the clustered distance profile array 262′ (after step 318) which demonstrates that the distance profiles 264, 266 that deviated from the cluster array 262 by more than the threshold value are now removed. In one example aspect, where the clusters 264, 266 are associated with plates 162b, 162c, the subsequent distance profile array 262′ generated after step 318 confirms that the remedial action taken in step 318 (e.g. adjusting the orientation of the bottle/plate on the head) resolved the operational condition.

### Hardware

FIG. 9 is a block diagram that illustrates a computer system 400 upon which an embodiment of the invention may be implemented. Computer system 400 includes a communication mechanism such as a bus 410 for passing information between other internal and external components of the computer system 400. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 400, or a portion thereof, constitutes a means for performing one or more steps of one or more methods described herein.

A sequence of binary digits constitutes digital data that is used to represent a number or code for a character. A bus 410 includes many parallel conductors of information so that information is transferred quickly among devices coupled to the bus 410. One or more processors 402 for processing information are coupled with the bus 410. A processor 402 performs a set of operations on information. The set of operations include bringing information in from the bus 410 and placing information on the bus 410. The set of operations also typically include comparing two or more units of information, shifting positions of units of information, and combining two or more units of information, such as by addition or multiplication. A sequence of operations to be executed by the processor 402 constitutes computer instructions.

Computer system 400 also includes a memory 404 coupled to bus 410. The memory 404, such as a random access memory (RAM) or other dynamic storage device, stores information including computer instructions. Dynamic memory allows information stored therein to be changed by the computer system 400. RAM allows a unit of information stored at a location called a memory address to be stored and retrieved independently of information at neighboring addresses. The memory 404 is also used by the processor 402 to store temporary values during execution of computer instructions. The computer system 400 also includes a read only memory (ROM) 406 or other static storage device coupled to the bus 410 for storing static information, including instructions, that is not changed by the computer system 400. Also coupled to bus 410 is a non-volatile (persistent) storage device 408, such as a magnetic disk or optical disk, for storing information, including instructions, that persists even when the computer system 400 is turned off or otherwise loses power.

Information, including instructions, is provided to the bus 410 for use by the processor from an external input device 412, such as a keyboard containing alphanumeric keys operated by a human user, or a sensor. A sensor detects conditions in its vicinity and transforms those detections into signals compatible with the signals used to represent information in computer system 400. Other external devices coupled to bus 410, used primarily for interacting with humans, include a display device 414, such as a cathode ray tube (CRT) or a liquid crystal display (LCD), for presenting images, and a pointing device 416, such as a mouse or a trackball or cursor direction keys, for controlling a position of a small cursor image presented on the display 414 and issuing commands associated with graphical elements presented on the display 414.

In the illustrated embodiment, special purpose hardware, such as an application specific integrated circuit (IC) 420, is coupled to bus 410. The special purpose hardware is configured to perform operations not performed by processor 402 quickly enough for special purposes. Examples of application specific ICs include graphics accelerator cards for generating images for display 414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 400 also includes one or more instances of a communications interface 470 coupled to bus 410. Communication interface 470 provides a two-way communication coupling to a variety of external devices that operate with their own processors, such as printers, scanners and external disks. In general the coupling is with a network link 478 that is connected to a local network 480 to which a variety of external devices with their own processors are connected. For example, communication interface 470 may be a parallel port or a serial port or a universal serial bus (USB) port on a personal computer. In some embodiments, communications interface 470 is an integrated services digital network (ISDN) card or a digital subscriber line (DSL) card or a telephone modem that provides an information communication connection to a corresponding type of telephone line. In some embodiments, a communication interface 470 is a cable modem that converts signals on bus 410 into signals for a communication connection over a coaxial cable or into optical signals for a communication connection over a fiber optic cable. As another example, communications interface 470 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 470 sends and receives electrical, acoustic or electromagnetic signals, including infrared and optical signals, that carry information streams, such as digital data.

The term computer-readable medium is used herein to refer to any medium that participates in providing information to processor 402, including instructions for execution. Such a medium may take many forms, including, but not limited to, non-volatile media, volatile media and transmission media. Non-volatile media include, for example, optical or magnetic disks, such as storage device 408. Volatile media include, for example, dynamic memory 404. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 402, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 402, except for carrier waves and other signals.

Logic encoded in one or more tangible media includes one or both of processor instructions on a computer-readable storage media and special purpose hardware, such as ASIC *420.

Network link 478 typically provides information communication through one or more networks to other devices that use or process the information. For example, network link 478 may provide a connection through local network 480 to a host computer 482 or to equipment 484 operated by an Internet Service Provider (ISP). ISP equipment 484 in turn provides data communication services through the public, world-wide packet-switching communication network of networks now commonly referred to as the Internet 490. A computer called a server 492 connected to the Internet provides a service in response to information received over the Internet. For example, server 492 provides information representing video data for presentation at display 414.

The invention is related to the use of computer system 400 for implementing the techniques described herein. According to one embodiment of the invention, those techniques are performed by computer system 400 in response to processor 402 executing one or more sequences of one or more instructions contained in memory 404. Such instructions, also called software and program code, may be read into memory 404 from another computer-readable medium such as storage device 408. Execution of the sequences of instructions contained in memory 404 causes processor 402 to perform the method steps described herein. In alternative embodiments, hardware, such as application specific integrated circuit 420, may be used in place of or in combination with software to implement the invention. Thus, embodiments of the invention are not limited to any specific combination of hardware and software.

The signals transmitted over network link 478 and other networks through communications interface 470, carry information to and from computer system 400. Computer system 400 can send and receive information, including program code, through the networks 480, 490 among others, through network link 478 and communications interface 470. In an example using the Internet 490, a server 492 transmits program code for a particular application, requested by a message sent from computer 400, through Internet 490, ISP equipment 484, local network 480 and communications interface 470. The received code may be executed by processor 402 as it is received, or may be stored in storage device 408 or other non-volatile storage for later execution, or both. In this manner, computer system 400 may obtain application program code in the form of a signal on a carrier wave.

Various forms of computer readable media may be involved in carrying one or more sequence of instructions or data or both to processor 402 for execution. For example, instructions and data may initially be carried on a magnetic disk of a remote computer such as host 482. The remote computer loads the instructions and data into its dynamic memory and sends the instructions and data over a telephone line using a modem. A modem local to the computer system 400 receives the instructions and data on a telephone line and uses an infra-red transmitter to convert the instructions and data to a signal on an infra-red a carrier wave serving as the network link 478. An infrared detector serving as communications interface 470 receives the instructions and data carried in the infrared signal and places information representing the instructions and data onto bus 410. Bus 410 carries the information to memory 404 from which processor 402 retrieves and executes the instructions using some of the data sent with the instructions. The instructions and data received in memory 404 may optionally be stored on storage device 408, either before or after execution by the processor 402.

FIG. 10 illustrates a chip set 500 upon which an embodiment of the invention may be implemented. Chip set 500 is programmed to perform one or more steps of a method described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 500, or a portion thereof, constitutes a means for performing one or more steps of a method described herein.

In one embodiment, the chip set 500 includes a communication mechanism such as a bus 501 for passing information among the components of the chip set 500. A processor 503 has connectivity to the bus 501 to execute instructions and process information stored in, for example, a memory 505. The processor 503 may include one or more processing cores with each core configured to perform independently. A multi-core processor enables multiprocessing within a single physical package. Examples of a multi-core processor include two, four, eight, or greater numbers of processing cores. Alternatively or in addition, the processor 503 may include one or more microprocessors configured in tandem via the bus 501 to enable independent execution of instructions, pipelining, and multithreading. The processor 503 may also be accompanied with one or more specialized components to perform certain processing functions and tasks such as one or more digital signal processors (DSP) 507, or one or more application-specific integrated circuits (ASIC) 509. A DSP 507 typically is configured to process real-world signals (e.g., sound) in real time independently of the processor 503. Similarly, an ASIC 509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 503 and accompanying components have connectivity to the memory 505 via the bus 501. The memory 505 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 505 also stores the data associated with or generated by the execution of one or more steps of the methods described herein.

FIG. 11 is a diagram of exemplary components of a mobile terminal 600 (e.g., cell phone handset) for communications, which is capable of operating in the system of FIG. 2, according to one embodiment. In some embodiments, mobile terminal 601, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 603, a Digital Signal Processor (DSP) 605, and a receiver/transmitter unit including a microphone gain control unit and a speaker gain control unit. A main display unit 607 provides a display to the user in support of various applications and mobile terminal functions that perform or support the steps as described herein. The display 607 includes display circuitry configured to display at least a portion of a user interface of the mobile terminal (e.g., mobile telephone). Additionally, the display 607 and display circuitry are configured to facilitate user control of at least some functions of the mobile terminal. An audio function circuitry 609 includes a microphone 611 and microphone amplifier that amplifies the speech signal output from the microphone 611. The amplified speech signal output from the microphone 611 is fed to a coder/decoder (CODEC) 613.

A radio section 615 amplifies power and converts frequency in order to communicate with a base station, which is included in a mobile communication system, via antenna 617. The power amplifier (PA) 619 and the transmitter/modulation circuitry are operationally responsive to the MCU 603, with an output from the PA 619 coupled to the duplexer 621 or circulator or antenna switch, as known in the art. The PA 619 also couples to a battery interface and power control unit 620.

In use, a user of mobile terminal 601 speaks into the microphone 611 and his or her voice along with any detected background noise is converted into an analog voltage. The analog voltage is then converted into a digital signal through the Analog to Digital Converter (ADC) 623. The control unit 603 routes the digital signal into the DSP 605 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 625 for compensation of any frequency-dependent impairments that occur during transmission though the air such as phase and amplitude distortion. After equalizing the bit stream, the modulator 627 combines the signal with a RF signal generated in the RF interface 629. The modulator 627 generates a sine wave by way of frequency or phase modulation. In order to prepare the signal for transmission, an up-converter 631 combines the sine wave output from the modulator 627 with another sine wave generated by a synthesizer 633 to achieve the desired frequency of transmission. The signal is then sent through a PA 619 to increase the signal to an appropriate power level. In practical systems, the PA 619 acts as a variable gain amplifier whose gain is controlled by the DSP 605 from information received from a network base station. The signal is then filtered within the duplexer 621 and optionally sent to an antenna coupler 635 to match impedances to provide maximum power transfer. Finally, the signal is transmitted via antenna 617 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 601 are received via antenna 617 and immediately amplified by a low noise amplifier (LNA) 637. A down-converter 639 lowers the carrier frequency while the demodulator 641 strips away the RF leaving only a digital bit stream. The signal then goes through the equalizer 625 and is processed by the DSP 605. A Digital to Analog Converter (DAC) 643 converts the signal and the resulting output is transmitted to the user through the speaker 645, all under control of a Main Control Unit (MCU) 603 which can be implemented as a Central Processing Unit (CPU) (not shown).

The MCU 603 receives various signals including input signals from the keyboard 647. The keyboard 647 and/or the MCU 603 in combination with other user input components (e.g., the microphone 611) comprise a user interface circuitry for managing user input. The MCU 603 runs a user interface software to facilitate user control of at least some functions of the mobile terminal 601 as described herein. The MCU 603 also delivers a display command and a switch command to the display 607 and to the speech output switching controller, respectively. Further, the MCU 603 exchanges information with the DSP 605 and can access an optionally incorporated SIM card 649 and a memory 651. In addition, the MCU 603 executes various control functions required of the terminal. The DSP 605 may, depending upon the implementation, perform any of a variety of conventional digital processing functions on the voice signals. Additionally, DSP 605 determines the background noise level of the local environment from the signals detected by microphone 611 and sets the gain of microphone 611 to a level selected to compensate for the natural tendency of the user of the mobile terminal 601.

The CODEC 613 includes the ADC 623 and DAC 643. The memory 651 stores various data including call incoming tone data and is capable of storing other data including music data received via, e.g., the global Internet. The software module could reside in RAM memory, flash memory, registers, or any other form of writable storage medium known in the art. The memory device 551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 549 carries, for instance, important information, such as the cellular phone number, the carrier supplying service, subscription details, and security information. The SIM card 549 serves primarily to identify the mobile terminal 501 on a radio network. The card 549 also contains a memory for storing a personal telephone number registry, text messages, and user specific mobile terminal settings.

In some embodiments, the mobile terminal 501 includes a digital camera comprising an array of optical detectors, such as charge coupled device (CCD) array 565. The output of the array is image data that is transferred to the MCU for further processing or storage in the memory 551 or both. In the illustrated embodiment, the light impinges on the optical array through a lens 563, such as a pin-hole lens or a material lens made of an optical grade glass or plastic material. In the illustrated embodiment, the mobile terminal 501 includes a light source 561, such as a LED to illuminate a subject for capture by the optical array, e.g., CCD 565. The light source is powered by the battery interface and power control module 520 and controlled by the MCU 503 based on instructions stored or loaded into the MCU 503.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus comprising:
a container carrier arranged in a travel lane, wherein said travel lane has a downstream direction in which the carrier is movable;
a panel comprising a fixed end and a free end, wherein said panel is positioned angled to and intersecting said travel lane, said free end being more proximal to said travel lane than said fixed end; and
a displacement sensor measuring a displacement at said panel.

2. The apparatus according to claim 1, wherein said apparatus further comprises a peeler bar upstream of said panel.

3. The apparatus according to claim 1, wherein said apparatus further comprises a label unwind mandrel, a peeler bar upstream of said panel, and a rewind mandrel, wherein said peeler bar is operationally positioned between said unwind mandrel and said rewind mandrel.

4. The apparatus according to claim 3, wherein said apparatus comprises a web carrying a plurality of pressure sensitive labels, wherein said web is bent over said peeler bar.

5. The apparatus according to claim 4, wherein said panel is operationally positioned to contact said pressure sensitive label when said pressure sensitive label is detached or partially detached from said web.

6. The apparatus according to claim 1, wherein the carrier comprises a plurality of spaced apart container carriers, wherein each of said carriers carries a container.

7. The apparatus according to claim 6, where said containers are arranged in the travel lane, wherein said free end is nearer to said travel lane than said fixed end and wherein said free end is positioned within said travel lane.

8. A method of detecting an operational condition of the apparatus according to claim 7, wherein said method comprises:
providing a plurality of containers engaged with said container carriers;
conveying said container carriers and containers engaged therewith past said panel;
measuring a distance from said displacement sensor to said panel as each container carrier is conveyed past said panel to generate a distance profile;
associating said distance profile with a unique said container carrier; and
recording each said distance profile associated with each said unique container carrier in a distance profile array associated with each said unique container carrier.

9. The method according to claim 8 further comprising determining a deviation amongst said distance profile array, wherein said operational condition is characterized by said deviation exceeding a threshold value.

10. The method according to claim 9, wherein said deviation amongst said distance profile arrays is determined by principle component analysis.

11. The method according to claim 9, wherein said deviation amongst said distance profile arrays is determined by decision tree classification.

12. The method according to claim 8, wherein said apparatus further comprises a label unwind mandrel, a peeler bar upstream of said deformable panel, and a rewind mandrel, wherein said peeler bar is operationally positioned between unwind mandrel and said rewind mandrel, wherein said apparatus comprises a web carrying a plurality of pressure sensitive labels, wherein said web is bent over said peeler bar; and
wherein said deformable panel is operationally positioned to contact said pressure sensitive label when said pressure sensitive label is detached or partially detached from said web to press one said pressure sensitive label onto one said container.

13. The method according to claim 8, wherein each of the plurality of containers is held by a neck holder as each of the plurality of containers is conveyed past said deformable panel, wherein each of the plurality of containers has an interior pressure applied thereto by said neck holder.

14. The method according to claim 8, wherein the displacement sensor comprises at least one of: a laser distance sensor, a magnetic sensor, a vibration sensor, an acoustic sensor and a visual sensor; strain gauge or other type of contact or non-contact sensor.

15. The method according to claim 9, wherein when the deviation amongst the distance profile array is identified, a corrective action is taken.

16. The method according to claim 9, wherein the distance profile array of one manufacturing location is compared to the distance profile array of another manufacturing location.

17. The method according to claim 9, wherein the distance profile array of a manufacturing line are compared to the distance profile array of another manufacturing line.

18. The method according to claim 9, wherein distance profile arrays are compared to reference profiles of the particular manufacturing line.
